(19) United States
(12) Patent Application Publication
(10) Pub. No.: US 2008/0033748 A1
(43) Pub. Date: Feb. 7, 2008

(54) System to measure and analyze the usage of dose reduction features

(76) Inventor: Erik Busch, Malvern, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/497,655

(22) Filed: Aug. 2, 2006

(51) Int. Cl. G06Q 10/00; G06F 19/00

(52) U.S. Cl. 705/2; 702/19

(57) ABSTRACT

A system and method are provided for optimizing user performance. The system and method comprise monitoring a user input for performing a task, determining whether an available option for purchase can perform the task better than an installed option, and indicating to the user results of the determination.

### BACKGROUND

1. Field of the Invention

The present invention is generally directed to medical imaging. More particularly, embodiments of the present invention are directed to a method and system for optimizing the radiation dose to a user and/or an operator and providing analysis of operating procedures via medical imaging equipment.

2. Background of the Invention

Medical care costs have been increasing ever year. Sometimes the percentage increase is in the double digits. Medical care providers blame the increase on malpractice insurance, high employee turnover, high training costs, and the high cost of medical equipment.

The high cost of medical care has affected how many consumers view the medical profession. Unfortunately, this view is sometimes negative. Consumers often feel that medical providers can control costs but medical providers know that consumers have no alternative other than to pay the higher costs.

Some people feel that there is a correlation among the problems facing medical providers such as high malpractice insurance, high employee turnover, high training costs, and the high cost of medical equipment. For example, if the employees are better trained, it may result in lower turnover and malpractice claims.

It is believed that employees do not always take advantage of the options and packages available in medical imaging equipment. For example, the cost of medical imaging equipment can be a few million dollars if all the available options and packages are selected. However, very rarely are all the options selected. Even when options and packages are selected with the purchase of medical imaging equipment, the options and packages may not be used correctly or used at all.

It is difficult for a medical provider to know which options and packages are being used for a medical imaging equipment. Medical equipment providers may provide training, but sometimes it is difficult to coordinate the schedules of the employees of the medical provider. Hence, some employees may not be trained at all or may have to rely on being taught by coworkers who have attended the training classes.

Some schools purchase medical imaging equipment and train their students on the equipment. One problem with this is that the schools may not always keep up with the latest options and packages. For example, due to costs, a school may only purchase options and packages that it feels are relevant. However, the schools students may eventually be employed at facilities where other options and packages are used.

A few medical imaging equipment manufacturers have systems that provide a demo for different features. A problem with this feature is that a user may be familiar with certain aspects of a specific option and package and become bored and lose interest at the beginning of the demo of the specific option and package and may miss critical information later on in the demo.

Thus, there is a need for a method and system that allows medical imaging equipment to be used efficiently.

### SUMMARY OF THE INVENTION

It is therefore an object of the present invention to provide a system and method where a patient and user are not over exposed to radiation, and where the system is interactive with a user. Preferably, this is accomplished in a manner in which optimum radiation exposure is provided to allow quality images to be acquired.

A system and method are provided for optimizing user performance. The system and method comprise monitoring a user input for performing a task, determining whether an available option for purchase can perform the task better than an installed option, and indicating to the user results of the determination.

In an aspect of the present invention, a medical imaging device provides an adequate amount of radiation dosage that limits exposure to the patient and operating personnel.

In another aspect of the present invention, a medical imaging device provides feedback that allows operating personnel to know when options available for purchase will provide better results than installed options.

### BRIEF DESCRIPTION OF THE DRAWINGS

A wide array of potential embodiments can be better understood through the following detailed description and the accompanying drawings in which:

FIG. 1 is a diagram illustrating an exemplary medical imaging device in accordance with an embodiment of the present invention;

FIG. 2 is a flow chart illustrating a process for measuring and analyzing the usage of dose reduction features in accordance with an embodiment of the present invention; and

FIG. 3 is a block diagram of a computer for optimizing user performance in accordance with an embodiment of the present invention.

In the drawings, the same or similar elements are denoted by the same reference numerals even though they are depicted in different drawings.

### DETAILED DESCRIPTION OF EXEMPLARY EMBODIMENTS

As required, detailed embodiments of the present inventions are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

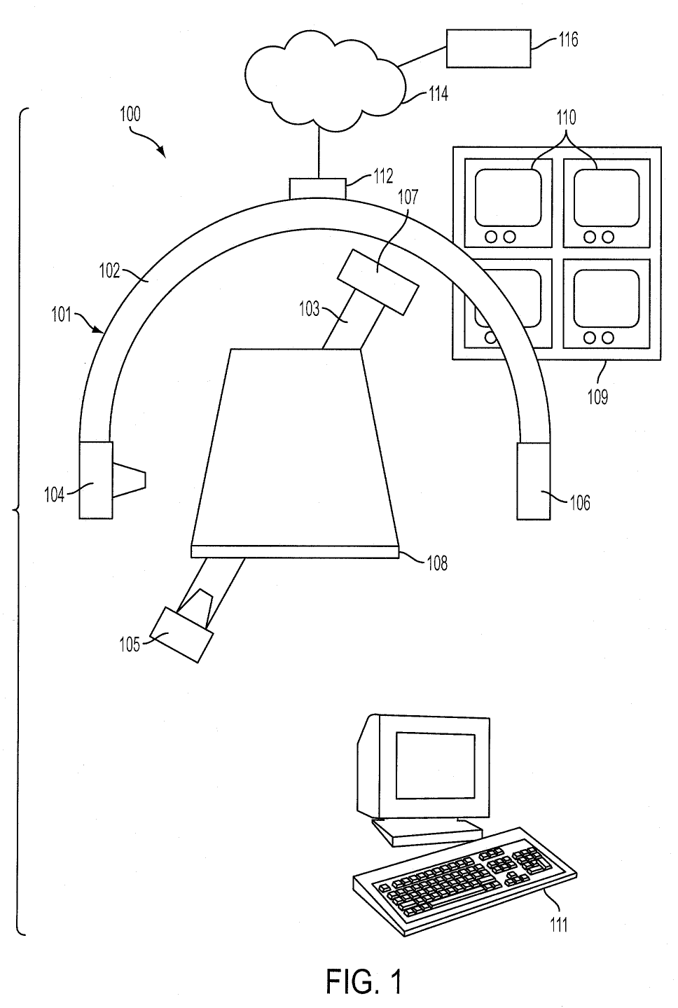

FIG. 1 is a diagram illustrating an exemplary medical imaging device 100 in accordance with an embodiment of the present invention. The medical imaging device comprises two C-arms 102 and 103, at the respective ends of which X-ray emitters 104 and 105 as well as X-ray detectors 106 and 107 situated opposite to each other in a known fashion. For example, flat detectors are installed.

It should be appreciated by those skilled in the art that the present invention can be performed without C-arms without departing from the scope of the present invention. For example, any medical imaging device having an emitter and detector can be used.

In addition, the medical imaging device 100 is provided with a patient examination table 108. For observation of the examination, a monitor support or monitor bank 109 is provided, in this example, comprising four monitors 110. However, a conventional medical imaging device 100 comprises at least one display.

An operating console 111 is located in an adjacent control room for communication with the system for the purpose of controlling the C-arms 102 and 103 and/or X-ray emitters 104 and 105 as well as X-ray detectors 106 and 107, image generation and image processing. Typically, an operating console 111 in the control room is provided with at least two monitors for biplane systems. It should be appreciated by those skilled in the art that other configurations are possible.

The C-arms 102 and 103 can be ceiling mounted and/or floor mounted. A combination of floor and ceiling mounted C-arms allows for adaptable positioning of the medical imaging device and fast programmable movement. It also allows peripheral examinations to be performed without repositioning a patient.

In accordance with an embodiment of the present invention, a processor 112 is provided for the medical imaging device 100. The processor 112 includes memory comprising information concerning the options that are installed on the medical imaging device 100 and the options that are available for medical imaging device 100.

For example, in medical imaging, the C-arm 102 and patient may be repositioned with respect to each other during a medical procedure. Typically, x-ray imaging systems operate in a fluoroscopic mode during the movement between positions in order to correctly reposition the C-arm.

Fluoroscopy is a technique that a radiologist or other technician uses during many diagnostic and therapeutic radiologic procedures to observe internal bodily images to assist with either the diagnosis or treatment of the patient. More specifically, a radiologist may obtain real time x-ray images of a patient using fluoroscopy. The real time x-ray images may be observed on the monitor bank 110 for evaluation.

A radiologist will acquire a first image of the patient using the medical imaging device 100. Subsequently, the radiologist will reposition the patient to a second position determined by the fluoroscopy. A second image of the patient may then be acquired at the second position. However, operation of the x-ray imaging system in the fluoroscopic mode may expose the patient to continuous low level radiation during repositioning.

In accordance with an embodiment of the present invention, the medical imaging device 100 will provide the radiologist with interactive information concerning the possibilities of the installed options, the possibilities of available options, and the possibilities of general application recommendations. It should be appreciated by those skilled in the art that other possibilities are possible without departing from the scope of the present invention, and that the invention is applicable to users other than radiologists.

In accordance with an embodiment of the present invention, the medical imaging system 100 provides a user with the results of calculations, trend analysis, benchmarking comparisons and recommendations for the purchase of available options based on at least one of new options that are being offered by the manufacturer either currently or in the future. The availability of purchase options may be based on past usage of the medical imaging device 100.

In accordance with a further embodiment of the present invention, the processor 112 enables the medical imaging device 100 to measure the times and applied radiation dose throughout all examinations. This can be done for a specific user or for a general location. The information from one medical imaging device can be collected or the information from a plurality of medical imaging devices located at a single location or a plurality of locations can also be collected.

The medical imaging system 100, in accordance with an embodiment of the present invention, can calculate actual dose reduction by using the installed options, calculate the potential dose savings by using the installed options, and calculate the potential dose savings by using other available options.

The processor 112 can collect information on updates to available options at predetermined intervals such as the evenings or weekends. In an embodiment of the present invention, user input information can be collected by the processor 112 and communicated over the network 114 to a processing center 116 such as the manufacturer or sales department. The information can be analyzed for trends and a determination can be made where training is needed per user or facility.

In a further embodiment of the present invention, in order to protect the privacy of the users or facility, the analysis can be performed locally by the medical imaging device 100. An option can be provided that based on the analysis performed locally, a salesperson contacts the medical provider to review the report, and/or discuss training or the purchase of new options.

One benefit of the present invention is that if an option is sold but not used, a determination can be made as to why the option is not being used. For example, if the medical imaging device 100 suggests a specific option to a user but the user is not using the option, corrective action can be performed in terms of targeted training to overcome the user's apprehension about using the option.

The following are exemplary options:

### Carematic

Automatic X-ray control system for fully automatic calculation and optimization of exposure data based on fluoroscopic values.

### Carefilter

Five-level adaptive Cu-prefiltration for reduction of skin dose; automatically guided selection depending on absorption.

Filters 0.1; 0.2; 0.3; 0.6; 0.9 mm Cu.

### Carevision

Pulsed fluoroscopy with additional reduced pulse frequencies from 0.5; 1.0; 2.0; 3.0; 4.0; 6.0*; 7.5 p/s.

Pulse frequency can be adjusted to the requirements of each application for significant reduction of radiation exposure, particularly during interventions

### Careprofile

Radiation-free positioning of primary and semi-transparent collimators via graphic display in LIH-image on the image monitor

### Careposition

With CAREPOSITION it is possible for the first time to perform visually controlled object positioning without radiation.

Radiation-free positioning via graphic display of the central X-ray beam and image edges in the LIH image on the image monitor.

When the table is moved, the current positions of the central beam and image edges are superimposed on the LIH image as orientation points.

### Carewatch

Electronic unit with DIAMENTOR, a measurement chamber integrated into the collimator housing for acquisition of area dose product.

Values displayed on the data display and image system monitor.

Different displays can be configured for fluoroscopy and for fluoro pause:

During fluoro area dose product.

During fluoro pause accumulated skin dose, or area dose product or percentage of a configurable dose limit value (amount of fluoro and radiography).

It should be appreciated by those skilled in the art that the names of the options are for illustration.

It should be appreciated by those skilled in the art that the present invention is not limited to medical imaging devices. The scope of the present invention covers applicable devices where equipment feedback provides user benefits. In addition, medical imaging device 100 is not limited to a specific type or field of medical imaging device. For example, a an angiography system is shown for illustrative purposes only. The medical imaging device can cover PET, SPECT, PET/SPECT, PET/CT and the like.

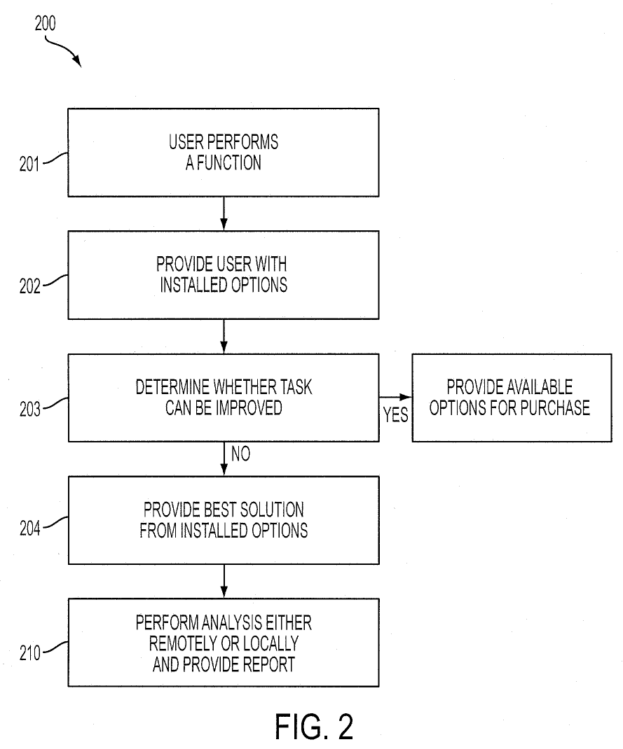

FIG. 2 is a flow chart illustrating a process 200 for measuring and analyzing the usage of dose reduction features in accordance with an embodiment of the present invention.

At step 201, a user performs a function such as fluoroscopy on the patient.

At step 202, the medical imaging device provides the user with installed options for performing the task.

At step 203, a determination is made as to whether the task can be improved such as reducing radiation exposure to the patient and/or user via available options.

At step 204, if the determination is affirmative, the user is provided with the information on available options for purchase. Benefits in terms of cost savings, time savings, reduced radiation exposure, improved imaging and the like. At step 205, if the determination is answered negatively, the user is provided with the best solution based on installed options.

At step 206, an analysis is performed either locally or remotely wherein user inputs are analyzed based on installed and available options. A report is provided for management and/or users concerning which options should be purchased and/or which options are not being properly utilized.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

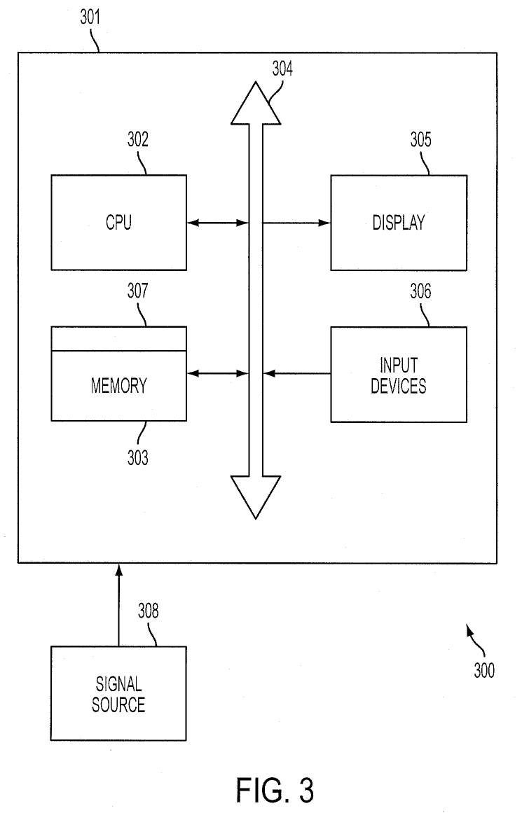

Referring now to FIG. 3, according to an embodiment of the present invention, a computer system 301 for implementing the present invention can comprise, inter alia, a central processing unit (CPU) 302, a memory 303 and an input/output (I/O) interface 304. The computer system 301 is generally coupled through the I/O interface 304 to a display 305 and various input devices 306 such as a mouse and a keyboard. The support circuits can include circuits such as cache, power supplies, clock circuits, and a communication bus. The memory 303 can include random access memory (RAM), read only memory (ROM), disk drive, tape drive, etc., or a combinations thereof. The present invention can be implemented as a routine 307 that is stored in memory 303 and executed by the CPU 302 to process the signal from the signal source 308. As such, the computer system 301 is a general purpose computer system that becomes a specific purpose computer system when executing the routine 307 of the present invention.

The computer system 301 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for optimizing user performance, the method comprising:
monitoring a user input for performing a task;
determining whether an available option for purchase can perform the task better than an installed option; and
indicating to the user results of the determination.

2. The method of claim 1, further comprising:
storing user inputs for requested tasks.

3. The method of claim 2, further comprising:
retrieving the stored user inputs.

4. The method of claim 3, further comprising:
analyzing the stored results for at least one of benchmarking comparisons, trend analysis and deficiencies in current installed options.

5. The method of claim 3, further comprising:
analyzing the stored results for training needs.

6. The method of claim 3, wherein the retrieval is performed remotely.

7. The method of claim 1, wherein the options are installed on a medical imaging device.

8. The method of claim 1, further comprising:
retrieving system updates at predetermined times.

9. The method of claim 8, wherein the system updates comprise new available options.

10. The method of claim 1, further comprising:
selecting an option that provides at least one of the user and patient with a lowest radiation exposure.

11. The method of claim 1, further comprising:
contacting a second user to discuss a purchase of the available option if the available option was selected as the best option.

12. The method of claim 1, further comprising:
selecting an appropriate installed option if the available option was selected.

13. A system for optimizing user performance, comprising:
an input device for inputting a set of parameters based on characteristics of the patient;
a table for adjusting a position of the patient;
at least one C-arm having radiation emitters and detectors at opposing ends for transmitting and detecting radiation;
a processor for determining whether an available option for purchase can perform the task better than an installed option; and
a display for displaying results of the determination.

14. The system of claim 13, further comprising:
a network for communicating the results of the determination to a second user.

15. The system of claim 13, wherein the radiation emitter comprises an X-ray emitter.

16. The system of claim 13, wherein the system comprises a medical imaging device.

17. The system of claim 13, wherein the processor provides at least one of benchmarking comparisons, trend analysis and deficiencies in current installed options.

18. The system of claim 13 further comprising a memory.

19. The system of claim 18, wherein the memory stores the results of the determination.

20. The system of claim 13, wherein the memory is located at least one of remotely from the system or locally with the system.
